(19) United States
(12) Patent Application Publication
(10) Pub. No.: US 2023/0252272 A1
(43) Pub. Date: Aug. 10, 2023

(54) NEURAL PROCESSING CELL

(71) Applicant: UNIVERSITY OF WOLVERHAMPTON, Wolverhampton (GB)

(72) Inventor: Ahsan ADEEL, Wolverhampton (GB)

(21) Appl. No.: 18/088,482

(22) Filed: Dec. 23, 2022

(30) Foreign Application Priority Data
Dec. 24, 2021 (GB) 2119011.1

(51) Int. Cl. G06N 3/048; G06N 3/063

(52) U.S. Cl. CPC G06N 3/048; G06N 3/063

(57) ABSTRACT

An apparatus (800), computer program (808) and method for performing execution of a computational neural layer comprising interconnected neural processing cells each comprising: a receptive field generator (‘S’, 104) configured to generate a receptive field (Sₜ) based on inputs (x¹ₜ-x^{N}ₜ) to which synaptic weights (W¹ₓ-W^{N}ₓ) are applied; a transfer function (‘A’, 106) configured to generate a field variable (Aₜ); and an activation circuit (‘Y’, 108) configured to generate an output (Yₜ) for controlling an activation level of the neural processing cell, based at least in part on the field variable, wherein the transfer function is dependent on: the receptive field; a local contextual field (Cₜ) dependent on a plurality of receptive fields (S²ₜ-S^{N}ₜ) of the other ones of the neural processing cells (102B, . . . ) of the computational neural layer; and a universal contextual field (Mₜ₋₁) indicative of a cross-cell memory state, based at least in part on previous output values of the neural processing cells.

### TECHNOLOGICAL FIELD

Embodiments of the present disclosure relate to a neural processing cell. Some relate to a computer program, an apparatus, a neural processing system and a method, relating to the design of a neural processing cell and a computational neural layer of a computational neural network.

### BACKGROUND

Leaky Integrate and Fire (LIF)-inspired multi-layer perceptron (MLP)-based deep neural networks (DNNs) have shown ground-breaking performance improvements in a wide range of real-world problems, ranging from image recognition to speech processing.

However, DNNs are often economically, technically, and environmentally unsustainable, especially in the field of low-energy resilient electronics. The problem is attributed to its dependence on the long established simplified LIF neural model that processes every piece of information it receives selfishly, irrespective of whether or not the information is useful. This self-centered approach increases the overall neural activity or contradictory messages at high perceptual levels, leading to energy-inefficient and hard-to-train DNNs. Furthermore, the lack of dynamic cooperation, coordination, and information sharing between neurons (neural processing cells) makes these models intolerant of faults with slow learning speed.

When a single LIF cell fires, it consumes significantly more energy compared to the equivalent computer operation, and an unnecessary fire not only affects the neurons it is directly connected to, but also others operating under the same energy constraint. Such models can learn, sense and perform complex tasks continuously, but at energy levels that may be unattainable for some processors. Therefore, the successful deployment of these systems in real-time is unrealistic.

At the same time, dependence on DNNs is growing rapidly, especially in time and energy sensitive real-world applications, including small healthcare devices, future autonomous companion robots in harsh environments, and driverless cars. To address the aforementioned problems, new brain-like energy-efficient and resilient computational platforms are required.

### BRIEF SUMMARY

According to various, but not necessarily all, embodiments there is provided a computer program that, when run on a computer, performs execution of a computational neural layer comprising interconnected neural processing cells each comprising:
a receptive field generator configured to generate a receptive field based on inputs to which synaptic weights are applied;
a transfer function configured to generate a field variable; and
an activation circuit configured to generate an output for controlling an activation level of the neural processing cell, based at least in part on the field variable, wherein the transfer function is dependent on:
   the receptive field;
   a local contextual field dependent on a plurality of receptive fields of the other ones of the neural processing cells of the computational neural layer; and
   a universal contextual field indicative of a cross-cell memory state, based at least in part on previous output values of the neural processing cells.

The integration of local and universal contextual fields as a modulatory force helps the transfer function and activation function to push relevant and irrelevant multimodal receptive fields to the right and left sides of the activation function (e.g., half-normal distribution filter), respectively. This enables the technical effect of significantly higher energy efficiency and resilience than existing architectures such as Leaky Integrate and Fire (LIF)-inspired multi-layer perceptron (MLP)-based deep neural networks.

According to various, but not necessarily all, embodiments there is provided an apparatus comprising: at least one processor; and at least one memory including computer program code, the at least one memory and the computer program code configured to, with the at least one processor, cause the apparatus at least to perform execution of a computational neural layer circuit comprising interconnected neural processing cell circuits each comprising:
a receptive field generator configured to generate a receptive field based on inputs to which synaptic weights are applied;
a transfer circuit configured to generate a field variable; and
an activation circuit configured to generate an output for controlling an activation level of the neural processing cell circuit, based at least in part on the field variable, wherein the transfer circuit is dependent on:
   the receptive field;
   a local contextual field dependent on a plurality of receptive fields of the other ones of the neural processing cell circuits of the computational neural layer circuit; and
a universal contextual field indicative of a cross-cell memory state, based at least in part on previous output values of the neural processing cell circuits.

According to various, but not necessarily all, embodiments there is provided a computer-implemented method of executing a computational neural layer comprising interconnected neural processing cells, the method comprising, for each neural processing cell:
causing execution of a receptive field generator configured to generate a receptive field based on inputs to which synaptic weights are applied;
causing execution of a transfer function configured to generate a field variable; and
causing execution of an activation circuit configured to generate an output for controlling an activation level of the neural processing cell, based at least in part on the field variable,
wherein the transfer function is dependent on:
   the receptive field;
   a local contextual field dependent on a plurality of receptive fields of the other ones of the neural processing cells of the computational neural layer; and
   a universal contextual field indicative of a cross-cell memory state, based at least in part on previous output values of the neural processing cells.

According to various, but not necessarily all, embodiments there is provided examples as claimed in the appended claims.

### BRIEF DESCRIPTION

Some examples will now be described with reference to the accompanying drawings in which:

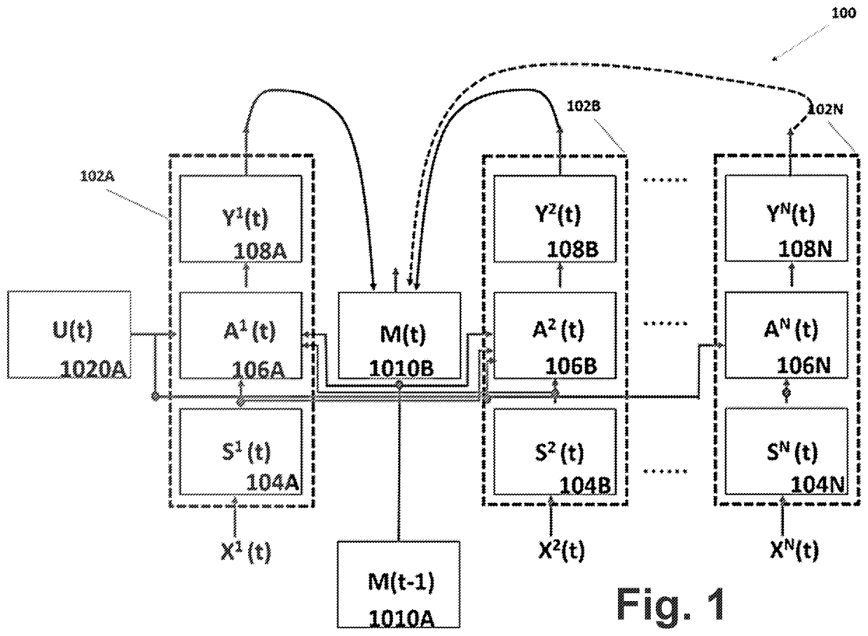

FIG. 1 illustrates an example of a computational neural layer comprising interconnected (cooperative) neural processing cells;

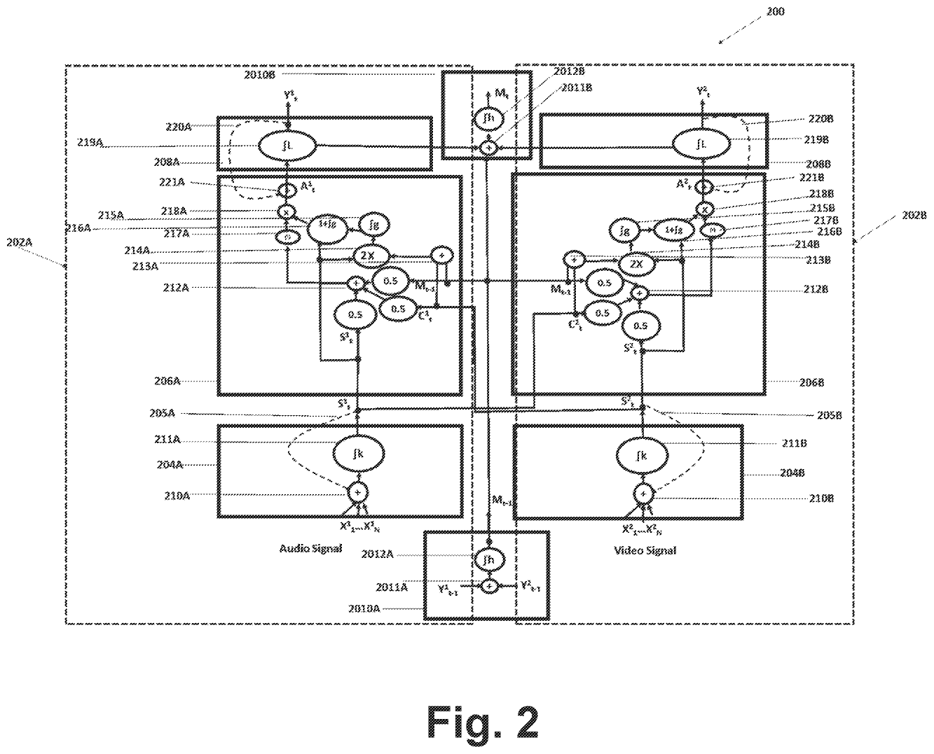

FIG. 2 illustrates an example of computational neural layer circuitry comprising interconnected neural processing cell circuitry;

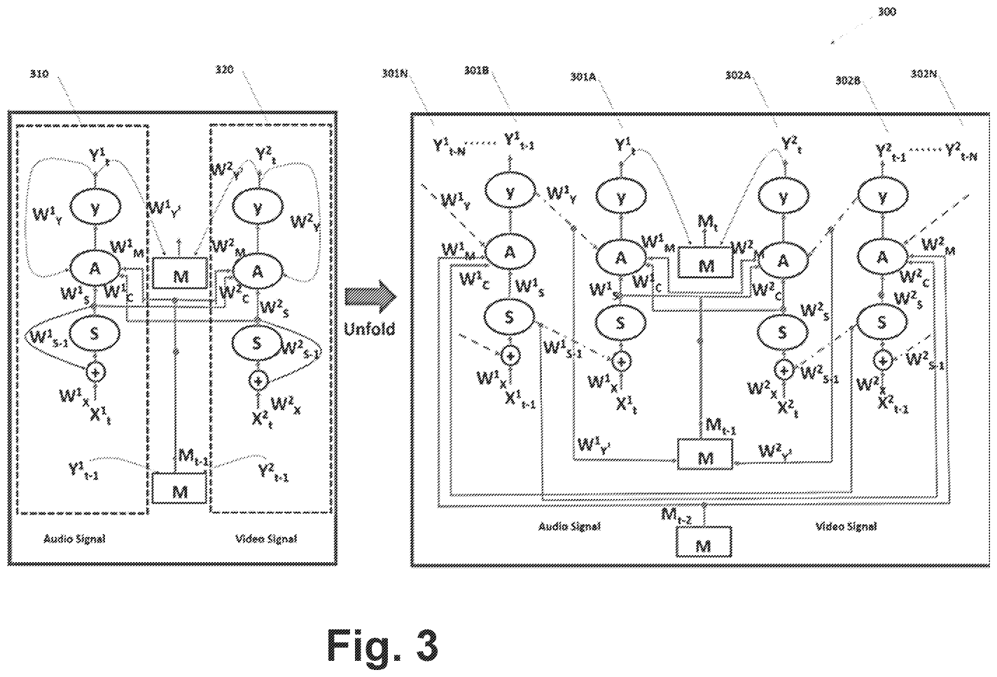

FIG. 3 illustrates an example of a training structure of a computational neural layer, including trainable weights;

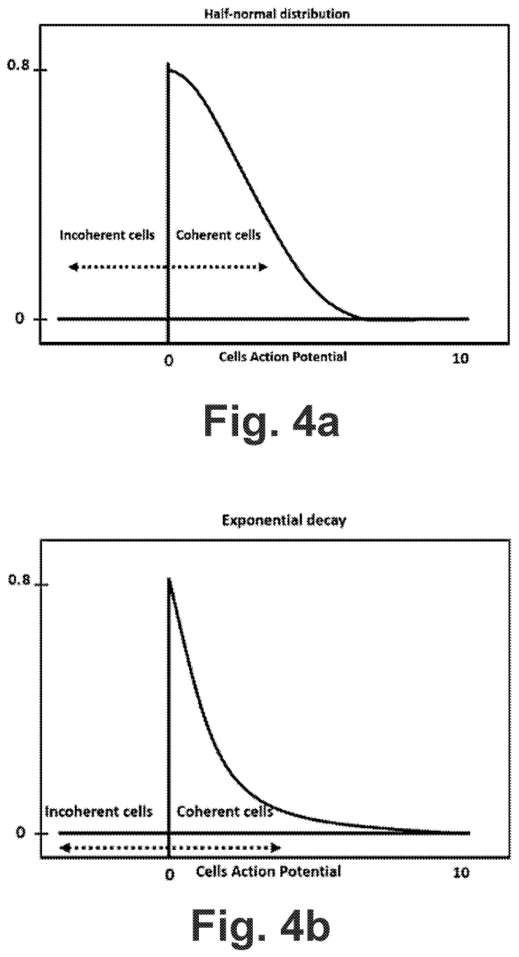

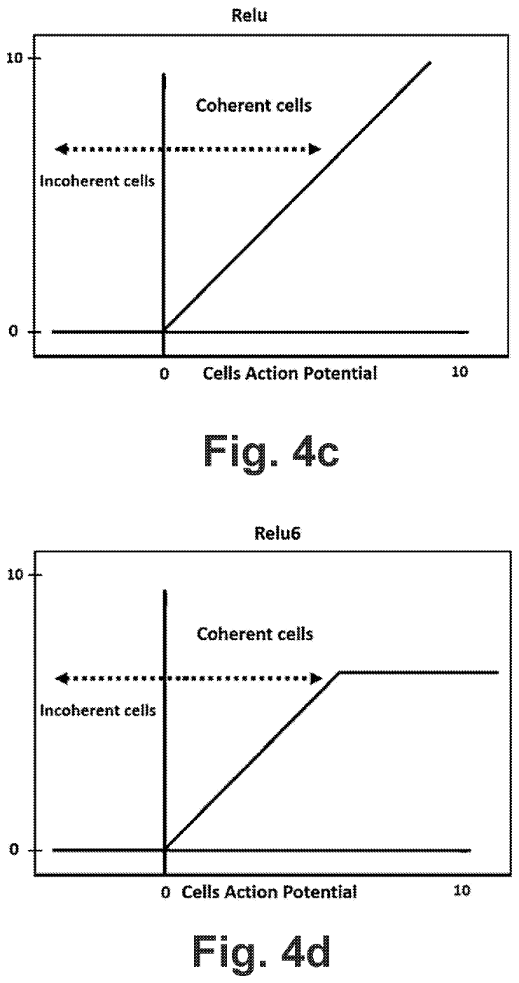

FIG. 4a illustrates an example of an activation function of an activation circuit of a neural processing cell, the activation function comprising a half-normal distribution;

FIG. 4b illustrates an example of an activation function of an activation circuit of a neural processing cell, the activation function comprising an exponential decay function;

FIG. 4c illustrates an example of an activation function of an activation circuit of a neural processing cell, the activation function comprising a rectified linear unit (ReLU);

FIG. 4d illustrates an example of an activation function of an activation circuit of a neural processing cell, the activation function comprising a modified rectified linear unit (ReLU6);

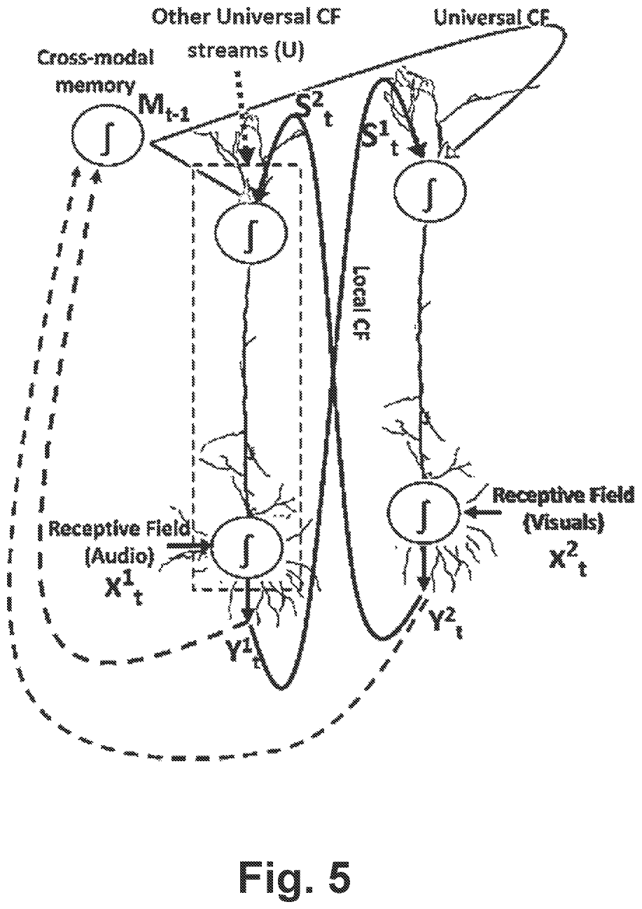

FIG. 5 illustrates an example of cooperation between two pyramidal neurons;

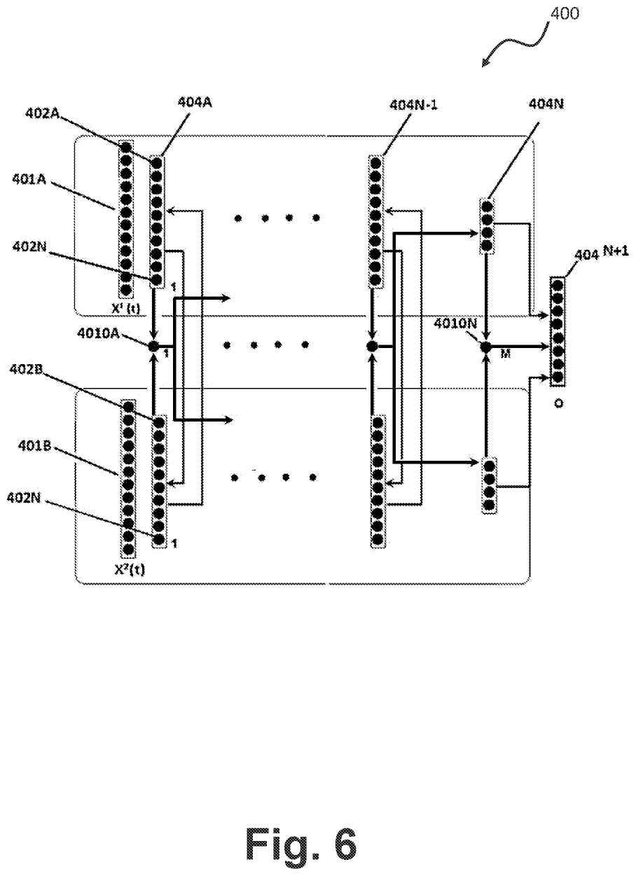

FIG. 6 illustrates an example of a computational neural network;

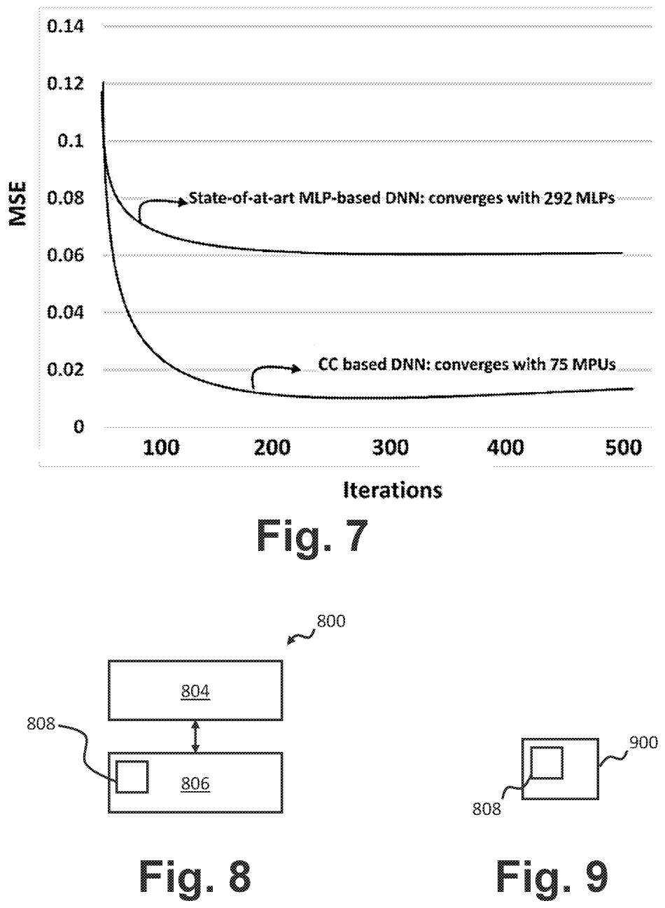

FIG. 7 illustrates example comparative training results;

FIG. 8 illustrates a controller; and

FIG. 9 illustrates a delivery mechanism.

### DETAILED DESCRIPTION

FIGS. 1-4d illustrate examples of a neural processing cell design and neural layer design. FIG. 5 illustrates an analogous biological layer 5 pyramidal cell. FIG. 6 illustrates a neural network design.

The invented neural processing system provides an energy-efficient and resilient computational platform. This is because each neural processing cell is configured as a Cooperative Processing Unit (CPU) to mimic the fundamental structure and function of the biological layer 5 pyramidal neuron, replacing the leaky integrate and fire (LIF) cell based neural structures with conscious multisensory integration driven neural design.

Each neural processing cell integrates contextual field (CF) information from other neural processing cells of a computational neural layer

CF comprises two different major kinds of CFs: Local CF (LCF) that comes from some other parts of the brain (in principle from anywhere in space-time) and universal CF which represents a cross-model memory state but could also include prior knowledge and anticipated behaviour (based on past learning and reasoning). Both CFs are integrated with the receptive field (RF) to achieve a precise amplification and suppression mechanism.

At time t−1, the CF only comprises the external context (LCF) e.g., processed visual streams at the audio channel which modulates the RF using the modulatory transfer function (transfer circuit) and activation function depicted in FIG. 4a-d.

The modulatory function is used as a force to push the action potential (AP) (neurons final output) to the right side of the modulatory transfer function if all incoming streams are coherent, otherwise to the left.

The extracted coherent RF signals are then fed into a cross-modal working memory to extract the synergistic components (UCF).

At time t, the LCF is combined with the synergistic signal (UC) to form CF which modulates (amplify or attenuate) the cell's responses to the feedforward RF input.

This mechanism effectively processes only the relevant (coherent) feedforward signals and discard all other irrelevant signals.

Coherent information refers to the portion of input information being processed being logical and consistent with other portions of input information from the source data.

If different neural processing cells handle different information modalities (e.g., audio and video) than each other, the cross-cell memory state can be regarded as a cross-modal memory state.

The neural processing cell processes information at three levels.

First, the receptive field transfer function of the neural processing cell integrates weighted inputs to form a weighted receptive field. The weighted receptive field is based on inputs to which synaptic weights have been applied. The synaptic weights may be specific to the neural processing cell. The inputs may be feedforward inputs.

Second, the modulatory transfer function of the neural processing cell matches the weighted receptive field (RF) with integrated local contextual field information and universal contextual field information each received from some or all other neural processing cells in neighbouring streams of the same computational neural layer.

A local contextual field indicates a current context coming from other parts of the computational neural layer/network. The local contextual field is based on the weighted receptive fields received by the RF transfer functions of the other neural processing cells during a current time step.

The universal contextual field is indicative of a cross-cell memory state and is based at least in part on the combined ‘output values’ of some or all of the other neural processing cells of the same computational neural layer at one or more previous time steps.

The term ‘output value’ refers to the output of an activation function applied to the modulatory output, i.e., the value that controls, at least in part, the final activation level of a neural processing cell.

if receptive and contextual fields are coherent, the activation function of the neural processing cell amplifies (e.g., pushes towards +∞) the output of the modulatory transfer function of the neural processing cell, otherwise it is suppressed (e.g., pushes towards −∞).

The contextual fields help with precisely amplifying or suppressing the receptive field. The activation function (FIGS. 4a-d) to discard (suppress) the negative receptive field and pass the positive receptive field linearly or non-linearly.

In the case of a spiky neural processing cell, a membrane potential of the neural processing cell increases or decreases based on the received coherent or incoherent received signals.

Simulation results demonstrate that this activity of dense cooperation, coordination, and information sharing allows each cell to become selective to what data is worth paying attention to and therefore processing just that, instead of having to process everything, leading to fast, energy-efficient, and resilient learning and processing.

In an audiovisual example, a realtime video recording from a camera can be used to clean the speech data from a microphone. This is useful, among other things, for embedding a low-energy neural network into a hearing aid.

This integration of contextual fields including local and universal contextual fields builds on recent neuroscience discoveries. These discoveries have revealed that the principal layer-pyramidal neuron in the cerebral cortex is context-sensitive and has two zones of integration, somatic and apical.

In the layer-5 pyramidal neuron, the activation of the apical zone serves as a context (i.e. Contextual Field (CF)) that selectively amplifies/suppresses the transmission of feedforward somatic input, driving different conscious states.

The inventor suggests that the apical input (CF), coming from the feedback and lateral connections, is multifaceted, and much more diverse and has far greater implications for ongoing learning and processing in the brain, than it is realized to date.

The inventor puts forward the idea of dissecting a well-established CF into LCF and UCF, to better understand the amplification and suppression of relevant and irrelevant signals, with respect to different external environments and anticipated behaviours.

LCF defines the modulatory sensory signal coming from some other parts of the brain (or in principle from anywhere in space-time) and UCF defines the outside environment and anticipated behaviour (based on past learning and reasoning).

The present neural processing cell integrates RF, LCF, and UCF as shown in the biological analogy of FIG. 5 and therefore acquires conscious multisensory integration characteristics.

FIG. 5 shows an interaction between two cooperative cells each integrating three functionally distinctive integrated input fields: RF (e.g., X¹ₜ, X²ₜ) as an external input, LCF (S¹ₜ or S²ₜ) as a modulatory field coming from the neighbouring cooperative cell, and modulatory cross-modal memory (UCF) as a net total (Mₜ₋₁). The UCF could include other subjective information (U); in addition to cross-modal memory or U could also be incorporated within M. The driving RF signals arrive via basal and perisomatic synapses, whereas the LCF and UCF signals arrive via synapses on the tuft dendrites at the top of the apical trunk.

Embodiments of the neural processing cell in a neural processing system can provide an energy-efficient and resilient computational platform. For example, in an embodiment, a neural processing system may comprise a plurality of neural network layers, each layer comprising a plurality of neural processing cells, each neural processing cell comprising a plurality of computational circuits, and each neural processing cell connected to a plurality of other neural processing cells in the same layer and to other neural processing cells in adjacent or neighbouring multimodal (or single-modal) streams of the same layer. The neural processing cells are interconnected through synapse circuitry adapted during training.

In at least some embodiments, each neural processing cell continuously transmits the context-indicative information it has to the lateral neural processing cells in the computational neural layer of the neural network, making sure a sudden death of the neural processing cell does not impact the system performance, or in the worst-case scenario, the performance degrades gracefully. Furthermore, before the neural processing cell transmits any information to those in the next layer, the information is matched with the contextual fields received from the neighbouring neurons (neural processing cells); if relevant to the situation, the information transmitted to the next layer is amplified, otherwise suppressed.

The smooth degradation characteristics makes the neural design advantageous for high-radiation environments such as space or nuclear sites, where loss of several neural processing cells can be expected.

The dense cooperation, coordination, and information sharing between different neural processing cells allow the network to be selective to what data is worth paying attention to and therefore processing just that, instead of having to process everything and iterate more times.

The dynamic neural activity reduces neural activation, and provides effective and energy efficient processing of a large amount of data using very limited computational resources.

An exemplary neural processing system 100 in which embodiments of the present systems and methods may be implemented is shown in FIG. 1.

The neural processing system 100 may comprise N neural processing cells 102A-N with N different streams of inputs X¹(t)-X^{N}(t).

Each neural processing cell 102A-N may contain a receptive field generator (blocks 104A-N). Each receptive field generator 104A-104N is configured to generate a receptive field S(t) based on a plurality of inputs X¹(t)-X^{N}(t). The inputs may be feedforward inputs. The inputs may be from a previous computational neural layer (not shown). The previous computational neural layer could be an input layer or a hidden layer or an output layer providing feedback.

The number of inputs may be the same as or (or less than) the number of neural processing cells 102A-N of the previous computational neural layer. The number of neural processing cells 102A-N of the previous computational neural layer may or may not be the same as the number of neural processing cells 102A-N of the illustrated computational neural layer.

The receptive fields S¹(t)-S^{N}(t) may represent an accumulative individual multimodal input, in examples where the individual inputs to the different neural processing cells 102A-N represent different information modalities. In an example, the term ‘accumulative’ refers to the already-weighted inputs being summed.

The receptive field generator 104A-N may be configured to apply an activation function k to the accumulative input. Each neural processing cell 102A-N may have a differently configured activation function k (e.g., different coefficients and/or biases, through training). The output of the activation function k is the receptive field S¹(t)-S^{N}(t).

Each receptive field generator 104A-104N may be configured to apply synaptic weights W¹ₓ-W^{N}ₓ to the inputs X¹(t)-X^{N}(t), or the received inputs may be already-weighted. The synaptic weights may be individual to each input as well as being individual to each neural processing cell 102A-N. The synaptic weights may be determined based on training of the neural processing system 100.

Each neural processing cell 102A-N may contain a modulatory transfer function 106A-N (also referred to herein as 3D asynchronous modulatory TF (3D-AMTF) blocks 106A-N). Each transfer function 106A-N is configured to generate a field variable A(t) referred to herein as an integrated field variable. 3D-AMTF refers to the ability of the function to in three major fields (RF, LCF, and UCF) in an asynchronous or non-linear manner. However, this could also be linear.

The field variable A¹(t)-A^{N}(t), when processed by the 3D AMTF, indicates the relevant and irrelevant activation levels of each neural processing cell 102A-N. As described earlier, the 3D AMTF integrates the receptive field, the local contextual field, and the universal contextual field, when calculating the field variable.

Each neural processing cell 102A-N may contain an output generation block 108A-N comprising an activation circuit implementing an activation function. The activation circuit of the output generation block 108A-N is configured to generate an output Y¹(t)-Y^{N}(t) (output value of the neural processing cell 102A-N) for controlling an activation level of the neural processing cell 102A-N. The activation function may process the field variable to determine the output value e.g., by discarding all the activation levels below zero, and pass the activation levels above 0 in a non-linear fashion as shown in FIG. 4 1-d. The output values Y¹(t)-Y^{N}(t) may act as the inputs X¹(t)-X^{N}(t) for the next computational neural layer.

In an example, a neural processing cell 102A may receive an audio signal X¹(t) that has been acquired at time t. The output signal S¹(t) of the receptive field generator 104A may be based on a weighted sum of the input values X¹(t)-X^{N}(t) using synaptic weights of respective input values.

For example, the output signal of the receptive field generator 104A may be S(t)=W₍ₓ₁₎*x₁+W₍ₓ₂₎*x₂ . . . +W_{(xN)}*x_{N} representative of an audio signal at time t. x₁ to x_{N} are the input values and W₍ₓ₁₎ to W_{(xN)} are the synaptic weights.

The receptive field generator 104A may be configured to apply an activation function k to S(t), for example, a sigmoidal or tan h function or any other linear or linear function. In some examples, the activation function k may be a function of S(t) and of a previous receptive field state S(t−1) from a previous time step. The activation function can be defined as: S(t)=k(W_{X}[(S(t−1), S(t))]+bₛ), incorporating the previously received signal S(t−1) at time t−1, and an associated bias bₛ. However, bias could be excluded in some cases.

Each transfer function block e.g., 106A may generate integrated field A¹(t) in dependence on:
the received signal S¹(t) as a receptive field;
S²(t)-S^{N}(t) as a local contextual field (C¹(t));
a previous cross-modal memory M(t−1) 1010A as a universal contextual field;
other contextual fields as prior knowledge or experiences (U) 1020A that could be any other contextual information coming from anywhere else in the network or could also be initiated by feeding an external input; and
a previous output value y¹(t−1).

An example implementation of the modulatory transfer function is given in Equations 1-5 below:

A¹(t)=0.5*S¹(t)+0.5*C¹(t)+0.5*M(t−1)*(1+(0.5*S¹(t)+0.5*C¹(t)+0.5*M(t−1))+g((S¹(t)[g((C¹(t)+M(t−1)))]+W¹y*Y¹(t−1) (Eq. 1)

### Or

A¹(t)=0.5*S¹(t)+0.5*C¹(t)+0.5*M(t−1)*(1+tan h((S¹(t)+0.5*C¹(t)+0.5*M(t−1)*(g((i C¹(t)+M(t−1))+W¹y*Y¹(t−1) (Eq. 2)

Or A¹(t) could be any other suitable modulatory function. The transfer function systematically (linearly or non-linearly) pushes (shifts/biases) the relevant (statistically coherent) signals to the right, positive side of the activation functions (FIG. 4a-d) and others to the left, negative side. The objective is to use A¹(t) as a force that enables this move.
where

M(t−1)=h(W¹_{Y}¹*Y¹(t−1), W²_{Y}²*Y²(t−1))+b_{M}] (Eq. 3)

Or ‘h’ could be any suitable transfer function that could systematically (linearly or non-linearly) integrate Y¹(t−1), Y²(t−1) . . . Y^{N}(t−1). The objective is to extract synergistic components. M could also integrate prior knowledge about the task (e.g., U) within (Eq. 2).
and

C¹(t)=W_{C}[S²(t), . . . S^{N}(t)], (Eq. 4)

Or LCFs (S²(t), . . . S^{N}(t)) could be systematically (linearly or non-linearly) integrated to achieve desired characteristics.
and

Y¹(t−1)=L(A¹(t−1)). (Eq. 5)

The previous values of the integrated field variable A(t−1) and the output value Y(t−1) may be the values calculated by the neural processing cell 102A for a previously received signal x(t−1).

In one example, the activation function g may be a sigmoidal activation function. In another example, the activation function of the receptive field block may be a tan h function. Similarly, in one example, the activation function L may be a half-normal distribution (FIG. 4a). In another example, the activation function of the receptive field block may be an exponential decay (FIG. 4b), a rectified linear unit (Relu) (FIG. 4c), or a modified rectified linear unit (Relu6) (FIG. 4d). For the very first received signal x(t), Y(t−1) and M(t−1) may be initialized with zero values.

The output generation blocks 108A-N may be configured to provide the output values Y¹(t)-Y^{N}(t) to a universal contextual field block 1010B (which becomes block 1010A at the next time step).

The output generation blocks 108A-N may be configured to generate an action potential to encode values of a variable at each time instant. The outputs Y¹(t)-Y^{N}(t) may be action potentials. The output generation blocks 108A-N may be configured to perform a rate-based coding such as firing rate. The output action potentials may for example be used over a range of time e.g., using a sequence of action potentials such as y(t−1), y(t−2) . . . y(t−n) generated for respective received signals S(t−1), S(t−2) . . . S(t−n) of a time period (t−1, . . . , t−n). The analysis of the sequence of outputs may be performed using a mean squared error (MSE) loss function e.g., a MSE between the network output y and a target value t or any other cost function with the aim to minimize or maximize any function or it could be fully unsupervised or semi-unsupervised.

FIG. 2 illustrates an example implementation of neural processing system 200 with only two neural processing cells 202A-B as a non-limiting example. FIG. 2 illustrates the status of the individual neural processing cells 202A-B after receiving signals x1(t) and x2(t). For example, the first neural processing cell 202A, comprises a receptive field generator 204A, transfer function block 206A, and an output generation block 208A. The second neural processing cell 202B, comprises a receptive field generator 204B, transfer function block 206B, and an output generation block 208B.

The receptive field generator 204A is configured to receive weighted input values W¹(x¹₁)*x¹₁, W¹x¹₂)*x¹₂ . . . W¹(x¹_{N})*x¹N representative of an audio signal (first information modality) at time t. The receptive field generator 204B is configured to receive weighted input values W2(x21)*x21, W2(x22)*x22 . . . W2(x2N)*x2N representative of a video signal (second information modality) at time t. The adder circuit 210A of the receptive field generator 204A may be configured to perform the sum of the received weighted values, the weighted previous receptive field state S¹ₜ₋₁ 205A and bias (the constant value b) such that

S¹(t)=k([W¹(x¹₁)*x¹₁+W¹(x¹₂)*x¹₂+ . . . +W¹(x¹_{N})*x¹_{N}]+W¹ₛ₋₁*S¹ₜ₋₁+b¹s). (Eq. 5)

The receptive field generator 204B of the second neural processing cell 202B may likewise comprise an adder circuit 210B configured to perform the sum of the received weighted values, the weighted previous receptive field state S²ₜ₋₁ 205B and bias (the constant value b) such that S²(t)=k([W²(x²₁)*x²₁+W²(x²₂)*x²₂+ . . . W²(x²_{N})*x²_{N}]+W²ₛ₋₁*S²ₜ₋₁+b²ₛ).

The receptive field generator 204A may comprise an activation circuit 211A configured to apply an activation function k e.g. tan h or sigmoid or any other or none to the output of 210A. The output of the activation circuit 211A is the receptive field S¹(t). The receptive field generator 204B of the second neural processing cell 202B may likewise comprise an activation circuit 211B configured to use an activation function k e.g. tan h or sigmoid or any other or none.

The receptive field generator 204A may be configured to use any other receptive field mechanisms e.g., random neural network, convolutional neural network, convolutional random neural network or any other variation of artificial neural network.

The illustrated transfer function block 206A comprises adder circuits 212A, 213A, multiplication circuits 214A and 218A and square circuit 217A, an activation circuit 215A, and an addition block 216A.

The adder circuit 212A adds up half of the receptive field (S¹ₜ) (first parameter), half of the local contextual field C¹ₜ (i.e., S²ₜ) (second parameter), and half of the universal contextual field (previous cross-modal memory state) (third parameter) (Mₜ₋₁) i.e., 0.5*S¹ₜ+0.5*S²ₜ+0.5*Mₜ₋₁. In other examples, the coefficients could be other than 0.5 and/or are not the same value and/or can include 0.0 e.g., when only receptive field is required: 0.0*S²ₜ+0.0*Mₜ₋₁. However, a coefficient is advantageous to induce an overall normalized effect to maximize the modulatory force and the objective of systematic movement of relevant and irrelevant signals to the right or left side of the transfer function. The coefficients could be tunable coefficients, and may be either trainable by the model or manually tuned.

The adder circuit 213A adds up the local contextual field C¹ₜ (i.e., S²ₜ), the universal contextual field (Mₜ₋₁), and another contextual field Uₜ (not shown in FIG. 2) if present e.g., prior knowledge about the target domain, experiences, rewards etc.

The multiplication circuit 214A multiplies the output of 213A with the receptive field (S¹ₜ). The illustrated circuit 214A multiples the output of 213A with the receptive field.

The output of multiplication circuit 214A is passed through an activation circuit 215A. The activation circuit 215A may be configured to apply its activation function on the computed product as follows: g(S¹ₜ(S²ₜ+Mₜ₋₁)). The activation circuit 215A may for example be a tan h function, sigmoidal function or any other on none (i.e., linear).

The square circuit 217A squares the output of the adder circuit 212A. The output of the square circuit 217A is then multiplied with the output of 216A by multiplication circuit 218A. The adder circuit 221A adds the output of multiplication circuit 218A with later-described feedback 220A.

The field variable output from 221A pushes AP to the positive side if the receptive field S¹ₜ, the local contextual field C¹₍ₜ₎, and the universal contextual field Mₜ₋₁ are coherent, and if they are not coherent pushes AP to the negative side.

The output generation block 208A may comprise an activation circuit 219A that discards the negative signals and processes the positive signals. The output generation block 208A could output a membrane potential in the case of a spiky central processing unit.

The activation circuit 219A may be configured to apply its activation function, for example a half-normal distribution (FIG. 4a), exponential decay (FIG. 4b), Relu (FIG. 4c), or Relu6 (FIG. 4d) or any other linear or non-linear thresholding function setting an activation threshold of the neural processing cell 202A, to the field variable A¹ₜ from the transfer function block 206A.

The output generation block 208A may also provide its generated output to the universal contextual field block 2010B (also referred to as a cross-modal memory block).

The output generation block 208A may also provide its generated output as feedback (fourth parameter) to the adder circuit 221A via feedback connection 220A, such that the adder circuit 221A can be described as: A¹ₜ=A¹ₜ+W¹_{Y}*Y¹ₜ₋₁. The objective is to introduce recurrence in the system. The connection 220A is shown as a dashed line to indicate that the connection 220A is with a time-lag such that at time step t as the neural processing system 200 is processing a received signal x¹(t) to generate corresponding S¹(t), A¹(t), and Y¹(t), the connection 220A may transmit a previous output value y¹(t−1).

The universal contextual field block 2010A-B may comprise an adder circuit 2011A-B and an activation circuit 2012A-B implementing an activation function h. The block 2010A at time t−1 integrates Y¹ₜ₋₁ and Y¹ₜ₋₁ to output synergistic components to be integrated into the contextual field at time t. The block 2010B does the same at time t for integration at time t+1.

The universal contextual field block 2010A-B acquires input from the output generation block 208A-B and may for example add and apply the activation function h of the activation circuit 2012A-B. The activation circuit 2012A-B may for example comprise a tan h function, exponential function, or sigmoidal function or any other suitable linear or non-linear function.

The transfer function block 206B of the second neural processing cell 202B may have the same functional circuitry as the first neural processing cell 202A. The suffix ‘B’ is used instead of ‘A’.

The output generation block 208B of the second neural processing cell 202B may have the same functional circuitry as the first neural processing cell 202A.

Based on the received field variable A²ₜ, the output generation block 208B may generate an output value to the neighbouring neural processing cell 202A in the same network steam 102B or other parallel multimodal network stream 102A, and also to the universal contextual field block 2010B, and to the adder circuit 221B such that: A²ₜ=A²ₜ+W²_{Y}*Y²ₜ₋₁. The connection 220B is shown as a dashed line for the same reason as explained above in relation to 220A.

FIG. 3 presents a training structure 300 (computational neural network) that may be used for training a given deep neural network comprising a number of neural processing cells e.g., 310 and 320 in two multimodal stream using a backpropagation (BP) or non-negative matrix factorization (NMF) technique or in case the proposed neural processing cell or system is modelled using spiking properties, local gradient based or other BP variants suitable for spiking neural network training could be used. The training algorithms may require an unrolled structure of the training structure 300. The training structure 300 may comprise neural processing cells 301A-N in one stream and neural processing cells 302A-N in stream B for each time step in a predefined time interval. The training structure 300 may be a software and hardware implemented structure. The training structure 300 may be trained for providing the values of the trainable weights W¹_{X}, W¹_{S}, W¹_{C}, W¹_{M}, W¹_{Y}, W¹_{Y}¹, W²Y² and associated b's (biases). However, the LCF and UCF could also be modelled as non-parametric fields without any weights. Each neural processing cell 302A-N in the training structure 300 may use for example a half-normal distribution (FIG. 4a), exponential decay (FIG. 4b), Relu (FIG. 4c), or Relu6 (FIG. 4d) or any other linear or non-linear suitable transfer function, for output Y(t).

The neural processing system of FIG. 4 was put to test using a well-established benchmark GRID and ChiME3 dataset for audio-visual (AV) speech mapping. The goal of AV speech mapping is to approximate the clean speech features in a noisy environment (e.g., −9 dB) using lip movements. For AV speech training and testing, a single speaker reciting 1000 sentences from the Grid corpus is used and the training and testing split is 70:30.

FIG. 6 presents the architecture of a computational neural network 400 comprising two input layers 401A-B, N hidden layers 404A-N, each comprising H hidden neural processing cells 402A-N, 402B-N in each hidden layer 404A-N, M universal contextual field blocks 4010A-N, and one output layer 404N+1 comprising O hidden neural processing cells 402A-N.

For the simulation, the architecture of FIG. 6 was used. The input x¹(t) is an audio signal (logFB features) and x²(t) is the visual signal (optimised DCT features). For training and testing, N=4 i.e., 4 layers for x¹(t) (top) and 4 layers for x²(t) bottom. Each layer comprises 50, 40, 30, and 20 cells, respectively. There is only one output layer (O=1), comprising 20 cells. In total there are 140 cells in the top layer, 140 cells in the bottom layer, and 20 cells in the output layer. In total there are 300 cells in the network. No regularization or dropout method is used instead the proposed methods inherently regularizes the network using transfer functions (FIG. 4a-d).

FIG. 7 depicts the training results. It can be seen that computational neural network 400 of the present disclosure (denoted ‘CC based DNN’) learns much faster than a state-of-the-art MLP based DNN. The present computational neural network 400 converges using only 75 neural processing cells (annotated as MPUs in FIG. 7) as compared to 292 MLPs on average for the MLP based DNN. During training, each neural processing cell in a DNN in evolves over the course of time and becomes highly sensitive to a specific type of high-level information and learns to amplify the relevant (meaningful) signals and suppress the irrelevant ones. The neural processing cell implementing examples of the present disclosure fires only when the received information is important for the task at hand. In contrast, the state-of-the-art MLP based DNN processes every piece of information it receives, irrespective of whether or not the information is useful. It can be seen that computational neural network 400 uses 74% fewer cells compared to MLP based DNN. Furthermore, the smaller number of cells used inherently makes the computational neural network 400 highly resilient against any sudden damage.

FIG. 8 illustrates an example of a controller 800. Implementation of a controller 800 may be as controller circuitry. The controller 800 may be implemented in hardware alone, have certain aspects in software including firmware alone or can be a combination of hardware and software (including firmware).

As illustrated in FIG. 8 the controller 800 may be implemented using instructions that enable hardware functionality, for example, by using executable instructions of a computer program 808 in a general-purpose or special-purpose processor 804 that may be stored on a computer readable storage medium (disk, memory etc) to be executed by such a processor 804.

The processor 804 is configured to read from and write to the memory 806. The processor 804 may also comprise an output interface via which data and/or commands are output by the processor 804 and an input interface via which data and/or commands are input to the processor 804.

The memory 806 stores a computer program 808 comprising computer program instructions (computer program code) that controls the operation of the apparatus 800 when loaded into the processor 804. The computer program instructions, of the computer program 808, provide the logic and routines that enables the apparatus to implement the computational neural networks described herein. The processor 804 by reading the memory 806 is able to load and execute the computer program 808.

The apparatus 800 therefore comprises: at least one processor 804; and at least one memory 806 including computer program code the at least one memory 806 and the computer program code configured to, with the at least one processor 804, cause the apparatus 800 at least to perform execution of a computational neural layer (404) comprising interconnected neural processing cells (102A, . . . ) each comprising:
a receptive field generator (‘S’, 104) configured to generate a receptive field (Sₜ) based on inputs (x¹ₜ-x^{N}ₜ) to which synaptic weights (W¹ₓ-W^{N}ₓ) are applied;
a transfer function (‘A’, 106) configured to generate a field variable (Aₜ); and
an activation circuit (‘Y’, 108) configured to generate an output (Yₜ) for controlling an activation level of the neural processing cell, based at least in part on the field variable, wherein the transfer function is dependent on:
   the receptive field;
   a local contextual field (Cₜ) dependent on a plurality of receptive fields (S²ₜ-S^{N}ₜ) of the other ones of the neural processing cells (102B, . . . ) of the computational neural layer; and
   a universal contextual field (Mₜ₋₁) indicative of a cross-cell memory state, based at least in part on previous output values (Y¹ₜ₋₁, Y²ₜ₋₁) of the neural processing cells.

As illustrated in FIG. 9, the computer program 808 may arrive at the apparatus 800 via any suitable delivery mechanism 900. The delivery mechanism 900 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid state memory, an article of manufacture that comprises or tangibly embodies the computer program 808. The delivery mechanism may be a signal configured to reliably transfer the computer program 808. The apparatus 800 may propagate or transmit the computer program 808 as a computer data signal.

Computer program instructions for causing an apparatus to perform at least the following or for performing at least the following:

cause performing execution of a computational neural layer (404) comprising interconnected neural processing cells (102A, . . . ) each comprising:
a receptive field generator (‘S’, 104) configured to generate a receptive field (Sₜ) based on inputs (x¹ₜ-x^{N}ₜ) to which synaptic weights (W¹ₓ-W^{N}ₓ) are applied;
a transfer function (‘A’, 106) configured to generate a field variable (Aₜ); and
an activation circuit (‘Y’, 108) configured to generate an output (Yₜ) for controlling an activation level of the neural processing cell, based at least in part on the field variable, wherein the transfer function is dependent on:
   the receptive field;
   a local contextual field (Cₜ) dependent on a plurality of receptive fields (S²ₜ-S^{N}ₜ) of the other ones of the neural processing cells (102B, . . . ) of the computational neural layer; and

a universal contextual field (Mₜ₋₁) indicative of a cross-cell memory state, based at least in part on previous output values (Y¹ₜ₋₁, Y²ₜ₋₁) of the neural processing cells.

The computer program instructions may be comprised in a computer program, a non-transitory computer readable medium, a computer program product, a machine readable medium. In some but not necessarily all examples, the computer program instructions may be distributed over more than one computer program.

Although the memory 806 is illustrated as a single component/circuitry it may be implemented as one or more separate components/circuitry some or all of which may be integrated/removable and/or may provide permanent/semi-permanent/dynamic/cached storage.

Although the processor 804 is illustrated as a single component/circuitry it may be implemented as one or more separate components/circuitry some or all of which may be integrated/removable. The processor 804 may be a single core or multi-core processor.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

Where a structural feature has been described, it may be replaced by means for performing one or more of the functions of the structural feature whether that function or those functions are explicitly or implicitly described.

The processing of the data, whether local or remote, may involve artificial intelligence or machine learning algorithms. The data may, for example, be used as learning input to train a machine learning network or may be used as a query input to a machine learning network, which provides a response.

The systems, apparatus, methods and computer programs may use machine learning which can include statistical learning. Machine learning is a field of computer science that gives computers the ability to learn without being explicitly programmed. The computer learns from experience E with respect to some class of tasks T and performance measure P if its performance at tasks in T, as measured by P, improves with experience E. The computer can often learn from prior training data to make predictions on future data. Machine learning includes wholly or partially supervised learning and wholly or partially unsupervised learning. It may enable discrete outputs (for example classification, clustering) and continuous outputs (for example regression).

The algorithms hereinbefore described may be applied to achieve the following technical effects: greater energy-efficiency; improved resilience to cell death.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’ or ‘the’ is used in this document with an inclusive not an exclusive meaning. That is any reference to X comprising a/the Y indicates that X may comprise only one Y or may comprise more than one Y unless the context clearly indicates the contrary. If it is intended to use ‘a’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/we claim:

1. A computer program that, when run on a computer, performs execution of a computational neural layer comprising interconnected neural processing cells each comprising:
a receptive field generator configured to generate a receptive field based on inputs to which synaptic weights are applied;
a transfer function configured to generate a field variable; and
an activation circuit configured to generate an output for controlling an activation level of the neural processing cell, based at least in part on the field variable,
wherein the transfer function is dependent on:
the receptive field;
a local contextual field dependent on a plurality of receptive fields of the other ones of the neural processing cells of the computational neural layer; and
a universal contextual field indicative of a cross-cell memory state, based at least in part on previous output values of the neural processing cells.

2. The computer program of claim 1, wherein the neural processing cells comprise a first neural processing cell configured to receive inputs corresponding to a first information modality, and a second neural processing cell configured to receive inputs corresponding to a second information modality, such that the universal contextual field is indicative of a cross-modal memory state.

3. The computer program of claim 1 or 2, wherein the transfer function is configured to sum a first parameter based on the receptive field, a second parameter based on the local contextual field, and a third parameter based on the universal contextual field.

4. The computer program of claim 3, wherein the transfer function is configured to compute the square of the sum.

5. The computer program of claim 3, wherein the relative contribution of each of the first, second and third parameters to the transfer function is tunable via coefficients.

6. The computer program of claim 1, wherein the transfer function is further dependent on a previous output value of the neural processing cell executing said transfer function.

7. The computer program of claim 1, wherein the transfer function is configured to apply an activation function to the receptive, local, and universal contextual fields and optionally one or more further contextual fields.

8. (canceled)

9. The computer program of claim 1, wherein the transfer function is configured to shift the field variable in a direction that depends on coherence of the contextual fields and the receptive field with each other, to enable the activation circuit to pass the field variable if the contextual fields and the receptive field are coherent with each other, and suppress or discard the field variable if the contextual fields and the receptive field are not coherent with each other.

10. The computer program of claim 1, wherein the universal contextual field comprises a function of individually weighted previous output values of the neural processing cells.

11. The computer program of claim 10, wherein the universal contextual field is based on a sum of the individually weighted previous output values of the neural processing cells.

12. The computer program of claim 10, wherein the function of the universal contextual field comprises an activation function.

13. (canceled)

14. The computer program of claim 12, wherein the activation function is configured to be applied to the sum of the previous output values of the neural processing cells.

15. The computer program of claim 1, wherein the receptive field generator is configured to generate the receptive field in dependence on the inputs and in dependence on a previous receptive field state of the receptive field generator.

16. The computer program of claim 1, wherein the receptive field generator is configured to apply an activation function to the inputs, the receptive field generator of each neural processing cell having a differently configured activation function.

17. The computer program of claim 1, wherein the activation circuit is configured to generate the output in dependence on the field variable and in dependence on a previous output value of the activation circuit.

18. The computer program of claim 1, wherein the activation circuit is configured to apply an activation function setting an activation threshold of the neural processing cell.

19. The computer program of claim 1, wherein each neural processing cell comprises one or more trainable weights to be applied to each of one or more of:
the inputs, when generating the receptive field, such that the synaptic weights are trainable weights;
the plurality of receptive fields, when generating the local contextual field; or
the previous output values of the neural processing cells, when generating the universal contextual field.

20. The computer program of claim 1, wherein the computer program, when run on a computer, performs execution of a computational neural network comprising:
hidden layers each configured as a neural processing layer as defined in claim 1; and
a universal contextual field block configured to store and provide to one or more of the hidden layers at a next time step a universal contextual field parameter based on the previous output values of the neural processing cells of a first one or more of the hidden layers.

21. A computational neural layer circuit comprising interconnected neural processing cell circuits each comprising:
a receptive field generator configured to generate a receptive field based on inputs to which synaptic weights are applied;
a transfer circuit configured to generate a field variable; and
an activation circuit configured to generate an output for controlling an activation level of the neural processing cell circuit, based at least in part on the field variable,
wherein the transfer circuit is dependent on:
the receptive field;
a local contextual field dependent on a plurality of receptive fields of the other ones of the neural processing cell circuits of the computational neural layer circuit; and
a universal contextual field indicative of a cross-cell memory state, based at least in part on previous output values of the neural processing cell circuits.

22. A method of executing a computational neural layer comprising interconnected neural processing cells, the method comprising, for each neural processing cell:
causing execution of a receptive field generator configured to generate a receptive field based on inputs to which synaptic weights are applied;
causing execution of a transfer function configured to generate a field variable; and
causing execution of an activation circuit configured to generate an output for controlling an activation level of the neural processing cell, based at least in part on the field variable,
wherein the transfer function is dependent on:
the receptive field;
a local contextual field dependent on a plurality of receptive fields of the other ones of the neural processing cells of the computational neural layer; and
a universal contextual field indicative of a cross-cell memory state, based at least in part on previous output values of the neural processing cells.
